(19) United States
(12) Patent Application Publication
(10) Pub. No.: US 2013/0273131 A1
(43) Pub. Date: Oct. 17, 2013

(54) Method of Manufacturing a Three-Dimensional Object by Use of Synthetic Powder Having Anti-Microbial Properties, and Synthetic Powder Having Anti-Microbial Properties for Such a Method

(71) Applicants: Arkema France, SA, Colombes (FR); EOS GmbH Electro Optical Systems, Krailling (DE)

(72) Inventors: Stoyan Frangov, Munich (DE); Peter Walz, Bonn (DE); Gregory Filou, Manneville sur Risle (FR)

(21) Appl. No.: 13/911,802

(22) Filed: Jun. 6, 2013

Related U.S. Application Data
(63) Continuation of application No. 12/755,892, filed on Apr. 7, 2010.

(30) Foreign Application Priority Data
Apr. 8, 2009 (DE) 102009016881.8

(51) Int. Cl. A01N 25/12

(52) U.S. Cl. CPC A01N 25/12
USPC 424/405

(57) ABSTRACT

A method is provided, in which three-dimensional objects are manufactured by layer-wise solidifying powdery synthetic material by impact of electromagnetic or particle radiation, wherein the powdery synthetic material has an anti-microbial property so that the manufactured objects comprise surfaces having an anti-microbial effect. The anti-microbial property is achieved by additives which are present in each powder grain. Such additives can be noble metals, for example argent. The manufactured objects are mainly used in particular in the food industry and in medical engineering.

The invention relates to a method of manufacturing a three-dimensional object, in which synthetic powder having anti-microbial properties is used. The invention further relates to such a synthetic powder having anti-microbial properties.

In certain areas, particularly in the food industry and in the medical area, it is required to keep surfaces of articles free from microbes, particularly from germs such as bacteria and viruses. A sterilization of the concerned surfaces is of often inevitable, but not practical for many applications and can technically not or hardly be performed. It is further known that such surfaces can be provided with anti-microbial coatings, which inhibit the progeny of microbes. Thereby, the anti-microbial effect of certain substances is used. For example, it is known that such anti-microbial coatings contain argent, whereby inhibiting certain metabolic processes of the microbes, and the microbes in turn can not be proliferated and are killed, respectively. In the area of manufacturing objects by selectively laser-sintering or selectively laser-melting, it is known from EP 1 911 468 A2 to manufacture an anti-microbial implant such that an argent powder is macroscopically mixed with bio-compatible powder such as titanium powder, and the mixture is then applied onto a substrate. The layer of the mixture is then selectively molten by impact of a laser. The whole implant can be manufactured layerwise, or a finished implant can be provided with an anti-microbial coating in this manner.

From EP-0 911 142 B1, a powder of polyamide 12, and from EP-1 431 595, a powder of polyamide 11 is known, which are suitable for laser-sintering, respectively.

It is the object of the invention to provide a method of manufacturing a three-dimensional object, by which objects having improved properties and a broader field of application can be generated.

This object is achieved by a method and a powdery synthetic material according to claims 1 and 11, respectively. Further developments of the invention are defined in the dependent claims.

The method has the advantage that, after the manufacture, the manufactured objects automatically have surfaces with an anti-microbial effect. The application field of laser-sintering synthetic material is thus broadened. For example, it is possible to manufacture articles now by laser-sintering, which have normally been manufactured by injection molding, and which are used in the food area and in the medical area.

A frequent and complex sterilization of surfaces of the manufactured objects can be avoided.

Further features and aims of the invention can be gathered from the description of embodiments on the basis of the Figures.

In the Figures show:

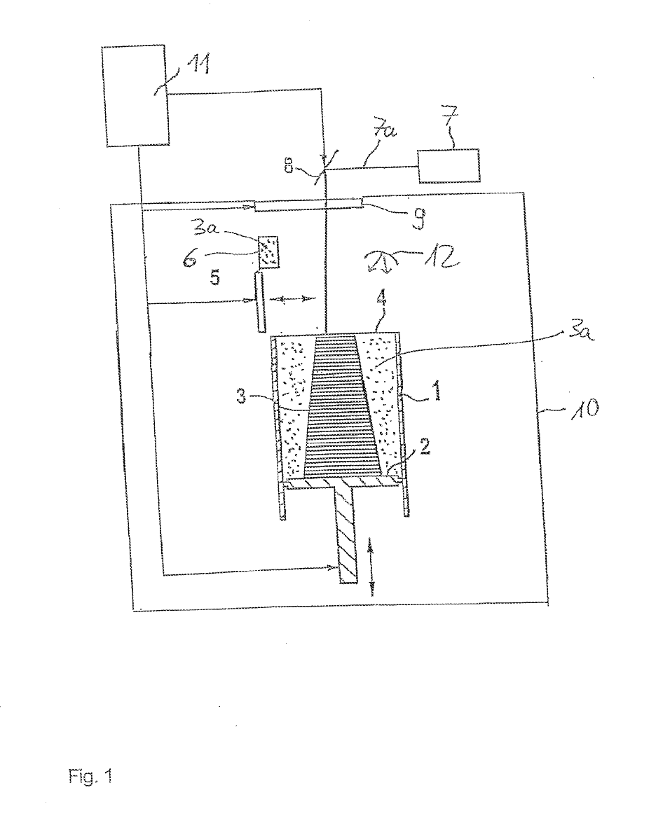

FIG. 1 a schematic view of a laser-sintering apparatus;

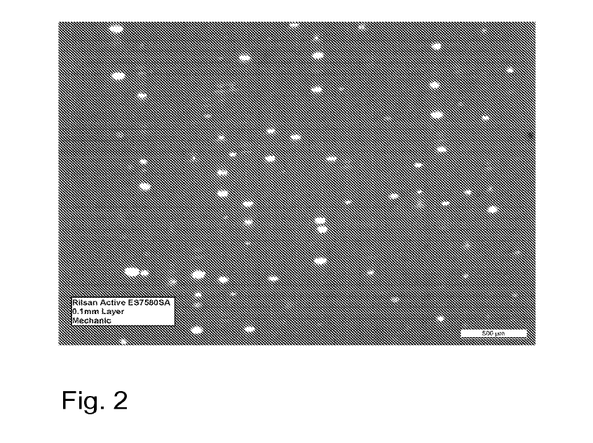

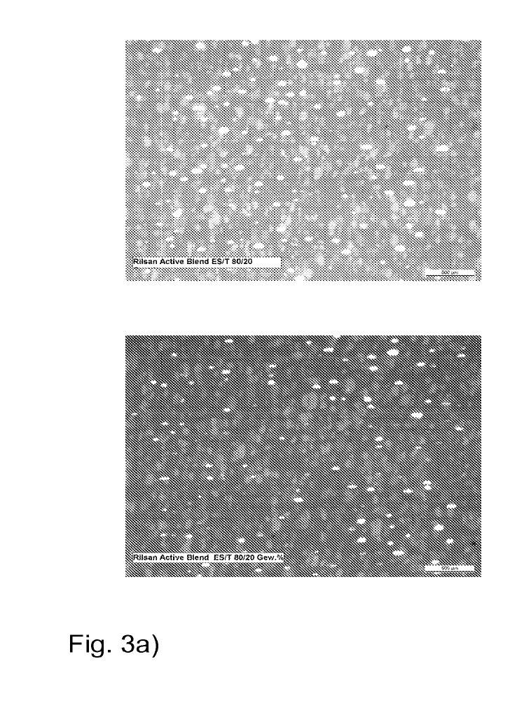

FIG. 2 a microscopic photo of a layer of solidified synthetic powder according to an embodiment;

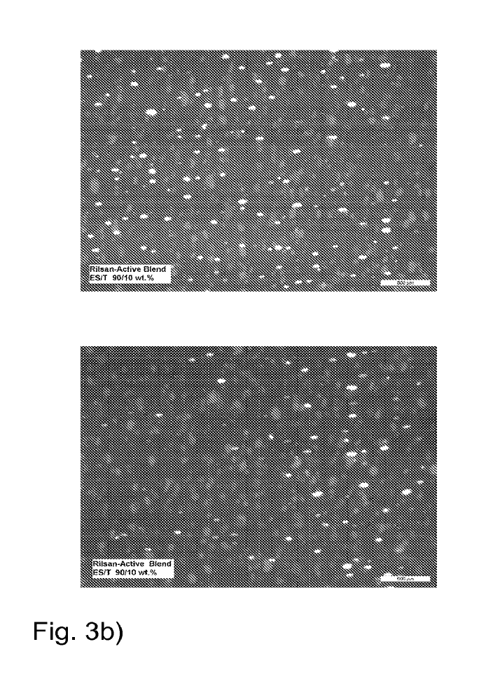

FIG. 3a) microscopic photos of sections having a thickness of 20 μm of a laser-sintered part which has been sintered with a further synthetic powder according to the invention;

FIG. 3b) microscopic photos of sections having a thickness of 20 μm of a laser-sintered part which has been sintered by another synthetic powder according to the invention.

The laser-sintering device as depicted in FIG. 1 comprises a container 1 which opens upwardly and has therein a support 2 being movably in the vertical direction and supporting the object 3 to be formed and defining a building field. The support 2 is adjusted in the vertical direction such that each layer of the object, which has to be solidified, lies in a working plane 4. Moreover, an applicator 5 for applying powdery building material 3a is provided, which can be solidified by electromagnetic radiation. The building material 3a is supplied to the applicator 5 from a storage container 6. The device further comprises a laser 7 generating a laser beam 7a, which is deflected by a deflection means 8 to an introduction window 9 and passed there through into the process chamber 10 and focused to a predetermined point in the working plane 4.

Further, a control unit 11 is provided, by which the components of the device are controlled in a coordinated manner to perform the building process.

The device can also comprise a heating means 12, by which a layer of the applied powder is heated to a working temperature below the melting point of the building material. Such heating means is particularly useful, when synthetic powder is used as building material.

The laser sintering method, which is known in principle, is executed such that the powder 3a is layerwise applied from the storage container 6 onto the support and a previously solidified layer, respectively, and is solidified by the laser at the locations in each layer corresponding to the cross-section of the object.

As building material, a powder having anti-microbial properties is used. Preferably, each single powder grain has the anti-microbial property. The anti-microbial property is to be understood that the progeny of microbes, which get in touch with the powder and the object formed thereof, respectively, is prevented or at least inhibited and/or the microbes are killed. The anti-microbial property encompasses the previously described effect against all microorganism, in particular bacteria and viruses.

The powdery building material consists of a synthetic powder, in particular a polymer as base material, preferably of a polyamide, in particular of polyamide 12 or polyamide 11. However, other synthetic powders are also conceivable such as polystyrene or polyarylene-ketone (PAEK) or polyether-ether-ketone (PEEK).

The base material is provided with an additive which effects the anti-microbial property. The anti-microbial additive contains substances having an anti-microbial effect. For example, such substances can be noble metals, in particular argent. At this time, the additive is distributed in the powder such that it is homogeneously present in each powder grain. Each powder grain thus has anti-bacterial properties. Preferably, the additive is present in the shape of argentiferous components like pure argent, silver nitrate or other salts of argent, silver ions and other additives.

By the above-mentioned method, all surfaces of the thus manufactured object have an anti-bacterial effect, since the additive having the anti-microbial property in each powder grain is present. It is further assured that in case of sintering parts having a porous structure, no microbes can be settled in the cavities, since also the surfaces of the walls of the cavities have an anti-bacterial effect.

The anti-microbial additive is present in a range from about 0.05 up to about 5 weight %, preferably in a range from about 0.1 up to about 2.0 weight %. The additive is not restricted to a single component, but it can also comprise several components.

In the following, concrete embodiments of the powder according to the invention and of the method according to the invention, respectively, are mentioned. In a first embodiment, purchasable polyamide 11 powder Rilsan® Active ES 7580 SA and Rilsan® Active T 7547 SA, available by the company Arkema, are used. Both powders have about 0.6 weight % argent additives, which are homogenously distributed in each powder grain. In Table 1, the general characteristics of these materials are indicated:

TABLE 1

| | | MVR (2.16/ | Trickle | bulk | | | |
|---|---|---|---|---|---|---|---|
| | | 235° C.) | time | density | Tₘ₁/Xₘ₁ | Tₘ₂/Xₘ₂ | Tc/Xc |
| Polymer | Viscosity | g/10 min | s | g/cm3 | ° C./% | ° C./% | ° C./% |
| ES 7580 SA | 0.88 | 131 | 5 (t₂₅) | 53 | 185/35 | 181/17 | 161.5/16.5 |
| T 7547 SA | 0.95 | 92.5 | 11 (t₁₅) | 59.2 | 185/35 | 179.5/17 | 157.8/17.5 |

Tₘ₁/Xₘ₁ is the melting point and the crystalline proportion at a first heating in a DSC-measurement. Tₘ₂/Xₘ₂ are the analogue values, when the sample is melted for a second time. T_{C}/X_{C} are the crystallization temperature and the crystalline proportion of the sample, which are determined in the DSC-measurement.

Table 2 and Table 3 show the grain size distribution of the above-mentioned powder.

TABLE 2

| | Polymer | | | | |
|---|---|---|---|---|---|
| | >100 μm | >80 μm | >63 μm | >50 μm | >20 μm |
| ES 7580 SA | 1.21% | 1.21% | 8.21% | 18% | 76.9% |

D50 is about 30-40 μm

TABLE 3

| | Polymer | | | | |
|---|---|---|---|---|---|
| | >254 μm | >202 μm | >160 μm | >80 μm | >40 μm |
| T 7547 SA | 1.16% | 5.4% | 16.48% | 19.52% | 1.58% |

D50 is about 110-130 μm

The D50-value means, that at least 50% of the powder grains have a size which is smaller than or equal to the indicated value.

Laser sintering experiments have been conducted with an EOSINT P390 of the applicant. Rilsan® Active ES 7580 SA has been applied with a layer thickness of 0.1 mm. The pre-heating temperature for each non-sintered layer was 180° C. The contour of the working piece in the layer has been irradiated twice. FIG. 2a) shows the microscopical photo of a laser-sintered part of Rilsan® Active ES 7580 SA. It can be gathered that the layers are well-molten.

In a further embodiment, a mixture of Rilsan® Active ES 7580 SA and Rilsan® Active T 7547 SA has been used. Both powders have homogeneously been mixed by a common cement mixer. The mixture time was about 20 minutes.

A first mixture contained therein the powder Rilsan® Active ES 7580 SA/Rilsan® Active T 7547 SA in a mixing ratio of 80/20 weight %. In a further example, the mixing ratio was 90/10 weight %.

The FIGS. 3a) and 3b) show sections having a thickness of through laser-sintered working pieces of the mixture Rilsan® Active ES7580 SA/Rilsan® Active G 7547 SA of 80/20 Weight % (FIGS. 3a)) and 90/10 weight % (FIG. 3h)). They have a homogeneous distribution of the proportion of Rilsan® Active T 7547 SA in a matrix of Rilsan® Active ES 7580 SA, which can be seen in the brighter areas compared with the darker environment.

In Table 4, the mechanical properties of the thus obtained working pieces are indicated.

TABLE 4

| | | Mixing 80/20 | Mixing 90/10 |
|---|---|---|---|
| Properties | ES 7580 SA | weight % | weight % |
| Young's Mod. | 1897 ± 73 | 1995 ± 90 | 2100 ± 90 |
| [MPa] | | | |
| Σmax [MPa] | 45.7 ± 1.6 | 49.3 ± 0.5 | 50.6 ± 1 |
| εB [%] | 6.5 ± 1.9 | 14.75 ± 1.8 | 14 ± 0.5 |
| ρ [kg m−3] | 1.14* | 1.12 | 1.16 |

The thus manufactured laser-sinter parts have the mechanical properties, which are required in practice. The surfaces and, in porosity, the inner surfaces of the thus manufactured parts have an anti-microbial property.

The presence of the anti-microbial additive does not exclude that the powder is supplemented by other additives in an arbitrary manner. The powdery synthetic material may also contain mixtures of different synthetic resins, in particular different polymers, preferably having the same chemical basis, from which all components of the mixture or only a part thereof may contain the anti-microbial additive.

The method is not restricted to the above-mentioned laser sintering. As energy source, also an electron beam or a spreaded-light or heating source can be used instead of a laser, by which the powder is molten and solidified. In case of the spreaded-light or heating source, the local solidification of a layer is realized by masks, for example.

1-51. (canceled)

52. Synthetic powder, which is suitable for manufacturing a three-dimensional object by layer-wise solidifying powdery building material at the locations corresponding to the object in each layer by impact of electromagnetic or particle radiation, wherein the synthetic powder has anti-microbial properties, wherein the synthetic powder has a D50 value between 20 pin and 150 preferably between about 304m and about 130 μm, in particular between 40 μm and 80 fumcomprises: a mixture of a first powder with a D50 value of 30-40 μm and second powder with a D50 value of 110-130 μm, and wherein each grain of powder comprises an anti-microbial additive, causing the synthetic powder to have an antimicrobial property, and wherein the D50 value of the first powder corresponds to a grain diameter for which the diameter of 50% of powder grains of the first powder are equal to or below, and wherein the D50 value of the second powder corresponds to a grain diameter for which the diameter of 50% of powder grains of the second powder are equal to or below.

53. Synthetic powder according to claim 52, wherein the synthetic powder contains a polymer.

54. Synthetic powder according to claim 53, wherein the synthetic powder contains at least one of polyamide 11 and polyamide 12.

55. Synthetic powder according to claim 53, wherein the additive contains a noble metal.

56. Synthetic powder according to claim 54, wherein the additive contains a noble metal.

57. Synthetic powder according to claim 55, wherein the noble metal is present in the form of a metal, as salt, or as ions.

58. Synthetic powder according to claim 53, wherein the additive is present in a ratio of about 0.05 up to about 5 weight %.

59. Synthetic powder according to claim 54, wherein the additive is present in a ratio of about 0.05 up to about 5 weight %.

60. Synthetic powder according to claim 55, wherein the additive is present in a ratio of about 0.05 up to about 5 weight %.

61. Synthetic powder according to claim 52, wherein the first powder with a D50 value of 30-40 pm and the second powder with a D50 value of 110-130 pm are present in a mixing ratio of 80/20 weight %.

62. Synthetic powder according to claim 52, wherein the first powder with a D50 value of 30-40 pm and the second powder with a D50 value of 110-130 pm are present in a mixing ratio of 90/10 weight %.

63. Synthetic powder according to claim 52, wherein the first powder with a D50 value of 30-40 μm and the second powder with a D50 value of 110-130 pm are homogeneously mixed.
